(19) United States
(12) Patent Application Publication
(10) Pub. No.: US 2021/0209804 A1
(43) Pub. Date: Jul. 8, 2021

(54) ENCODED DATA TRANSMISSION AND DETECTION

(71) Applicant: Lenovo (Singapore) Pte. Ltd., Singapore (SG)

(72) Inventors: Kenneth Scott Seethaler, Raleigh, NC (US); Adam Jerome Cavenaugh, Cary, NC (US); David W. Douglas, Cary, NC (US); Hidetoshi Mori, Kanagawa-ken (JP)

(21) Appl. No.: 16/735,278

(22) Filed: Jan. 6, 2020

(51) Int. Cl. G06T 9/00; G06T 3/40; H04L 29/06; G06F 1/16

(52) U.S. Cl. CPC G06T 9/00; G06T 3/40; G06F 1/1616; G06F 1/1686; H04L 65/607

(57) ABSTRACT

One embodiment provides a method, including: detecting, using a camera of an information handling device, an encoded image displayed on a display of another device; and deciphering, using a processor, the encoded image to produce a decoded dataset. Another embodiments provides a method, including: encoding, using a processor of an information handling device, data; presenting, on a display of the information handling device the encoded data in a visual pattern; and transmitting, to at least one other device, an indication that the encoded data is being presented; wherein the information handling device is a clamshell device and wherein the display is positioned on a portion of the A-cover. Other aspects are described and claimed.

### BACKGROUND

Data of all types (e.g., files, documents, images, videos, other types of data, etc.) are frequently transmitted between information handling devices (“devices”), for example laptop and/or personal computers, tablet devices, smart phones, and the like. The means for data transmission may be conducted over a wired or wireless connection and may be facilitated by interaction with various applications resident on the device. For example, users may send data via an emailing application, a texting application, a social media application, a conferencing application, another data transmission application, and the like.

### BRIEF SUMMARY

In summary, one aspect provides a method, comprising: detecting, using a camera of an information handling device, an encoded image displayed on a display of another device; and deciphering, using a processor, the encoded image to produce a decoded dataset.

Another aspect provides an information handling device, comprising: a display; a camera; a processor; a memory device that stores instructions executable by the processor to: detect, using the camera, an encoded image displayed on a display of another device; and decipher the encoded image to produce a decoded dataset.

A further aspect provides a method, comprising: encoding, using a processor of an information handling device, data; presenting, on a display of the information handling device the encoded data in a visual pattern; and transmitting, to at least one other device, an indication that the encoded data is being presented; wherein the information handling device is a clamshell device and wherein the display is positioned on a portion of the A-cover.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of detecting and deciphering encoded data.

FIG. 4 illustrates an example method of encoding and transmitting encoded data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A variety of issues exist with conventional data transmission techniques. For example, data transmitted over a private or public network may be susceptible to interception or hacking. As another example, file size restrictions may prevent data larger than a predetermined file size from being transmitted. In yet another example, the transmitter and the recipient may be operating their devices on different networks (e.g., guest Wi-Fi vs. company Wi-Fi, etc.), which may cause certain issues. In yet another example, if BLUETOOTH or another Near Field Communication (NFC) technique is used to transmit data, the transmitting and receiving device must first be paired, which may be burdensome and/or time-consuming. Additionally, users run the risk of automatically connecting to devices that may be insecure.

Accordingly, an embodiment provides a method for using an optical transmission technique to transmit and receive data. In an embodiment, data may be encoded into a visual pattern (e.g., within successive frames, etc.) that may thereafter be presented on a display of the device. In an embodiment, the device may be a clamshell type device (e.g., a laptop, another foldable device, etc.) and the display may be an auxiliary display positioned along a portion of the A-cover (i.e., the top cover) of the clamshell device. The displayed pattern may thereafter be detected by a camera sensor of another device. For example, another laptop device may be in the line of sight of the user's device (e.g., positioned across from the user's device, etc.) and may have a world-view camera sensor positioned on its A-cover capable of capturing images and/or videos of objects within its field of view. This arrangement may allow the camera of the other device to capture an image of the displayed pattern, decipher it (e.g., using a decoding algorithm, etc.), and thereafter perform one or more downstream functions (e.g., save the data, act on the data, etc.). Such a method may provide a data transmission method that is both simple, secure, and not subject to conventional file size restrictions.

The illustrated example embodiments will be best understood by reference to the figures. The following description is intended only by way of example, and simply illustrates certain example embodiments.

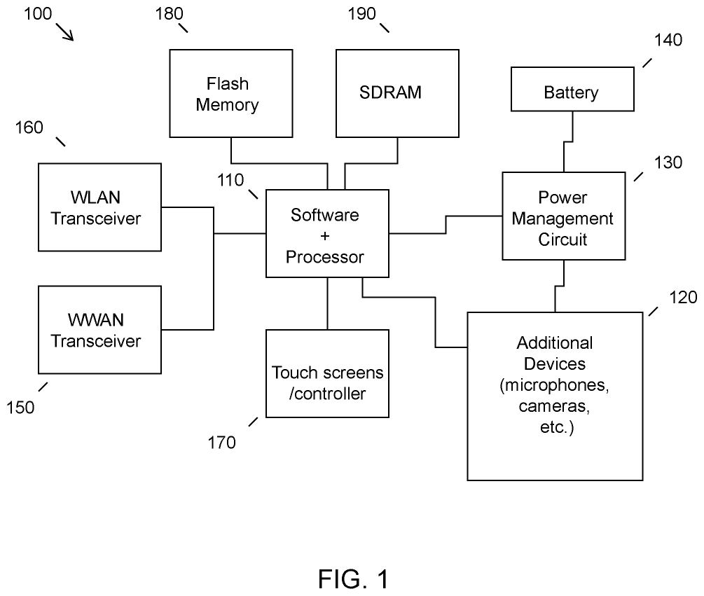

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

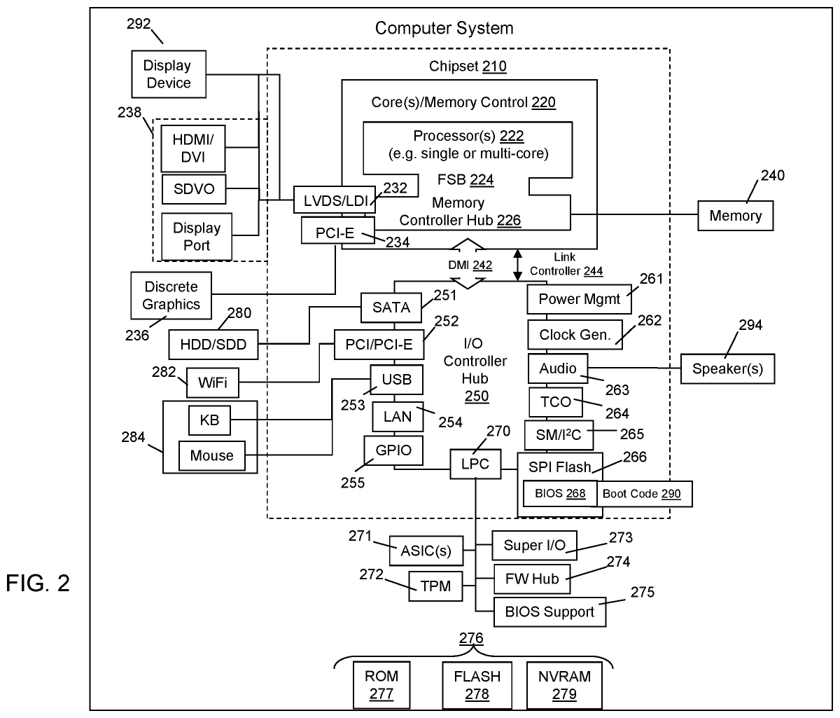

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of supporting both a camera and an auxiliary display, potentially both positioned on the same surface. For example, the circuitry outlined in FIG. 1 may be implemented in a smart phone or tablet embodiment, whereas the circuitry outlined in FIG. 2 may be implemented in a laptop.

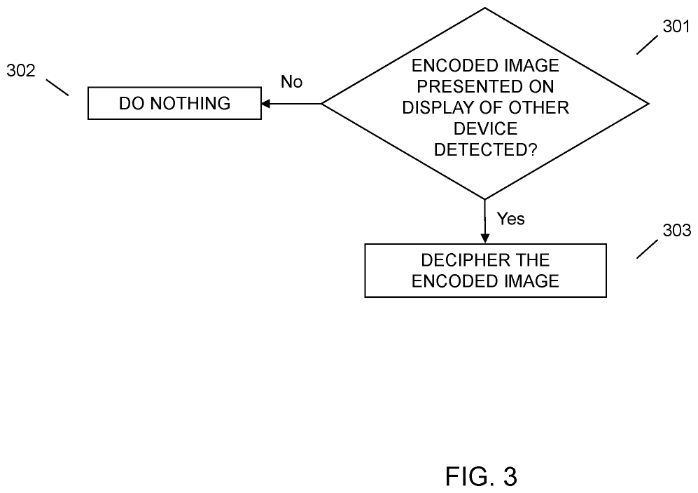

Referring now to FIG. 3, an embodiment provides a method for encoded data transmission via an optimal transmission technique. More particularly, FIG. 3 describes a method of detecting, deciphering, and utilizing encoded data transmitted by another device. At 301, an embodiment may detect the presence of an encoded image on a display of another device. In the context of this application, an encoded image may refer to data (e.g., files, documents, images, videos, etc.) that has been encoded into successive frames of a predetermined visual pattern. In an embodiment, the display on which the encoded image is presented may correspond to any type of thin: liquid crystal display (LCD), light-emitting diode (LED) display, or organic light-emitting diode (OLED) display.

In an embodiment, the transmitting device may be a multi-display device containing a primary display and at least one auxiliary display. The auxiliary display may be positioned on the same or different surface as the primary display and may contain the same or different dimensions and/or resolution characteristics as the primary display. In an embodiment, the encoded image may be presented solely on the primary display, solely on the auxiliary display, or on all of the displays substantially simultaneously. For simplicity purposes, the remainder of this application will be described with reference to a clamshell-type transmitting device (e.g., a laptop, etc.) containing an auxiliary display on the A-cover (i.e., the top cover) and a primary display on the B-cover, wherein the encoded image is presented solely on the auxiliary display. However, such a designation is not limiting and a skilled person will recognize that the encoded image may be presented in different ways using varying display configurations, as previously discussed.

The detection of the encoded image may be facilitated by use of a camera integrated into the device. In an embodiment, the camera of the device may be always-on and may continually monitor for any encoded image that happens to enter its field of view. Conversely, in another embodiment, the camera may originally be in an off-state until an indication is received from another device (e.g., from a wake-up communication, a signal detection, a “digital handshake”, etc.) to activate and to monitor for an encoded image. Responsive to activating, an embodiment may access an available ruleset (e.g., stored locally on the device or remotely on another device or server, etc.) to inform itself what to monitor for (i.e., the types of objects corresponding to an encoded image or a device displaying the encoded image). Once an encoded image is detected, an embodiment may capture one or more images or videos of it.

In an embodiment, the camera may be positioned virtually anywhere on the detecting device. For example, in an embodiment, the detecting device may be a clamshell type device (e.g., a laptop, etc.) and the camera may be positioned on an A-cover of the device. In this configuration, the camera may be a worldview camera that may be capable of capturing images and/or videos of objects in front of the detecting device. Accordingly, if the transmitting device were positioned substantially in front of the detecting device in a back-to-back arrangement the encoded image presented on the auxiliary display of the transmitting device may be detected by the worldview camera of the detecting device.

Alternatively to the foregoing, in another embodiment, the camera may be integrated into a smart hub device that is capable of supporting conference video calls. In this arrangement, the camera may be a 360-degree camera capable of capturing a 360 degree image or video of the surrounding space. In an embodiment, any images or videos of encoded images detected by the smart hub device may be transmitted to one or more other devices (e.g., the devices associated with the remote conference attendees, etc.) via the video stream. In this way, data traffic may be encoded in an optical format over a conference call. Additionally, due to the 360-degree nature of the camera, the smart hub device does not necessarily need to be positioned across from the transmitting device, but rather, may be positioned in a variety of locations within the space occupied by the transmitting device. Accordingly, the foregoing transmission techniques allow any conference attendee to easily and securely share data not just with the local conference attendees, but also with the remote ones. For example, a conference attendee may encode a file and present, on an auxiliary display of their device, an encoded image containing the contents of that file. The smart hub device may thereafter detect the encoded image and transmit the encoded image to the remote conference attendees and/or the local ones.

It is important to note that each of the transmitting and detecting devices may contain both: an auxiliary display and a camera. Additionally, these devices may exchange roles when the situation demands. More particularly, the original transmitting device may act as the detecting device when data is attempted to be transmitted from the original detecting device to the original transmitting device. Additionally, in an embodiment, the detecting device may be able to detect one encoded image at a time or, alternatively, may be able to detect a multitude of encoded images substantially simultaneously. Regarding the latter, if multitudes of transmitting devices within a field of view of the camera present the encoded image on their auxiliary display at once, then the detecting device may be able to effectively detect each encoded image within its field of view substantially simultaneously.

Accordingly, responsive to not detecting, at 301, an encoded image presented on a display of a transmitting device, an embodiment may, at 302, do nothing. Conversely, responsive to detecting, at 301, an encoded image presented on a display of a transmitting device, an embodiment may, at 303, decipher or decode the encoded image to produce a decoded dataset that corresponds to the data that was intended to be transferred. In an embodiment, the deciphering may be accomplished by utilizing a decoding algorithm that is known by and/or accessible to the detecting device (e.g., stored in a local storage location on the detecting device, stored on a remote device or server that is accessible to the detecting device, etc.). In an embodiment, once the decoded dataset is produced, an embodiment may automatically perform at least one function on it. For example, an embodiment may automatically: save the decoded dataset down into a local storage location, activate and display the dataset (e.g., in the case of a document, image, or video, etc.), send a confirmation receipt to the transmitting device, or perform other functions not explicitly listed here.

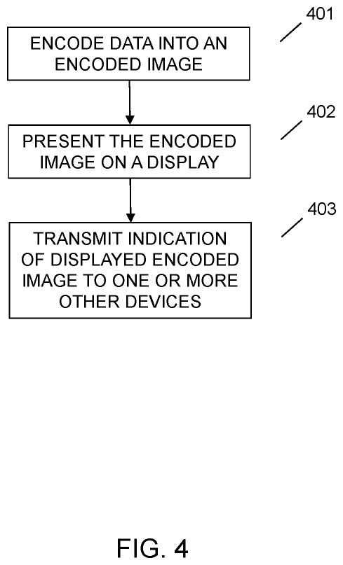

Referring now to FIG. 4, an embodiment provides a method of encoding and transmitting data to one or more other devices. At 401, an embodiment may encode data onto a visual pattern (as previously described). For example, a user may select an item (e.g., file, document, image, video, etc.) that they want to be transferred to another device and select (e.g., from a drop-down menu, etc.) an option to encode the item into the aforementioned visual pattern (i.e., the encoded image). Responsive to this selection, an embodiment may, at 402, encode the item and present the encoded image on a display of the device. For example, the encoded image may be presented on an auxiliary display positioned on the A-cover of a clamshell device.

At 403, an embodiment may transmit an indication to at least one other device that informs the other device(s) to activate a camera to monitor for encoded data that is about to be, or is currently being, presented. The indication, as previously described, may take a variety of different forms such as a signal transmission, an electronic handshake, etc. When an image or video of the encoded image is captured by the other device, it can thereafter be considered transmitted to the other device, at which point it may be decoded and acted upon by processors of the other device. In an embodiment, the other device may already have knowledge of the appropriate decoding algorithm necessary to decode the encoded image or, alternatively, the decoding algorithm may be communicated to the other device separately or as part of the handshake signal transmission. Although described here as a step occurring after the presentation of the encoded image, it is important to note that this is not limiting and the transmission of the indication to monitor may occur prior to presentation of the encoded image on the auxiliary display.

The various embodiments described herein thus represent a technical improvement to conventional methods data transmission. Using the techniques described herein, an embodiment may be able to detect, using a camera, an encoded image displayed on a screen of another device. Responsive to deciphering the encoded image (e.g., using a decoding algorithm, etc.), an embodiment may be able to access the transmitted contents. Additionally, from the alternative perspective, an embodiment may be able to encode data into a predetermined visual pattern and thereafter present that encoded data image on a display (e.g., an auxiliary display, etc.) of the device to be captured and deciphered by one or more other devices. Such a technique provides for a simple and secure way to transmit data from one device to another.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, using a camera of an information handling device, an encoded image displayed on a display of another device; and
deciphering, using a processor, the encoded image to produce a decoded dataset.

2. The method of claim 1, wherein the information handling device is a clamshell device and wherein the another device is another clamshell device positioned within a field of view of the camera of the information handling device.

3. The method of claim 2, wherein the camera is positioned on a portion of an A-cover of the information handling device.

4. The method of claim 1, wherein the information handling device is a smart hub and wherein the camera of the information handling is a 360-degree worldview camera.

5. The method of claim 4, further comprising transmitting, from the smart hub and in a video transmission, the encoded image to at least one other remote device.

6. The method of claim 1, wherein the decoded dataset corresponds to data selected from the group consisting of a file, a document, an image, and a video.

7. The method of claim 1, further comprising performing, responsive to the decoding, at least one function based on the decoded data.

8. The method of claim 1, wherein the deciphering the encoded image comprises deciphering via utilization of a decoding algorithm accessible by the information handling device.

9. The method of claim 1, wherein the detecting comprises:
receiving, from the another device, an indication that the encoded image will be displayed; and
activating, responsive to the receiving, the camera to monitor for the encoded image.

10. The method of claim 1, wherein the detecting comprises:
maintaining the camera in an always-on mode; and
continuously monitoring for the encoded image to enter a field of view of the camera.

11. An information handling device, comprising:
a display;
a camera;
a processor;
a memory device that stores instructions executable by the processor to:
detect, using the camera, an encoded image displayed on a display of another device; and
decipher the encoded image to produce a decoded dataset.

12. The information handling device of claim 11, wherein the information handling device is a clamshell device and wherein the another device is another clamshell device positioned within a field of view of the camera of the information handling device.

13. The information handling device of claim 12, wherein the camera is positioned on a portion of an A-cover of the information handling device.

14. The information handling device of claim 11, method of claim 1, wherein the information handling device is a smart hub and wherein the camera of the information handling is a 360-degree worldview camera.

15. The information handling device of claim 14, wherein the instructions are further executable by the processor to transmit, from the smart hub and in a video transmission, the encoded image to at least one other remote device.

16. The information handling device of claim 11, wherein the encoded dataset corresponds to data selected from the group consisting of a file, a document, an image, and a video.

17. The information handling device of claim 11, wherein the instructions are further executable by the processor to perform, responsive to the decoding, at least one function based on the decoded data.

18. The information handling device of claim 11, wherein the instructions executable by the processor to decipher the encoded image comprise instructions executable by the processor to decipher via utilization of a decoding algorithm accessible by the information handling device.

19. The information handling device of claim 11, wherein the instructions executable by the processor to detect comprise instructions executable by the processor to:
receive, from the another device, an indication that the encoded image will be displayed; and
activate, responsive to the receiving, the camera to monitor for the encoded image.

20. A method, comprising:
encoding, using a processor of an information handling device, data;
presenting, on a display of the information handling device the encoded data in a visual pattern; and
transmitting, to at least one other device, an indication that the encoded data is being presented;
wherein the information handling device is a clamshell device and wherein the display is positioned on a portion of the A-cover.
